(19) United States
(12) Patent Application Publication
(10) Pub. No.: US 2007/0168420 A1
(43) Pub. Date: Jul. 19, 2007

(54) Method and apparatus for providing customized subscription data

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 11/323,762

(22) Filed: Dec. 30, 2005

(51) Int. Cl. G06F 15/16

(52) U.S. Cl. 709/204

(57) ABSTRACT

A method and system are described for providing customized subscription data. According to an exemplary embodiment, a method is described for receiving a subscription request for a tuple via a publish/subscribe protocol from a subscriber, and sending a first message related to the subscription request to a publisher capable of providing customized information associated with the tuple, where the customized information is based on a characteristic of the first message. The method further indudes receiving from the publisher a second message including the customized information and in response to receiving the second message, constructing a notification including the customized information and using the publish/subscribe protocol to send the notification including the customized information to the subscriber.

### RELATED APPLICATIONS

The present application is related to co-pending U.S. patent application Ser. No. 11/160,612, entitled “METHOD AND APPARATUS FOR BROWSING NETWORK RESOURCES USING AN ASYNCHRONOUS COMMUNICATIONS PROTOCOL,” filed on Jun. 30, 2005, and assigned to the assignee of the present application. The present application is also related to co-pending U.S. patent application Ser. No. 11/160,157, entitled “METHOD, SYSTEM, AND DATA STRUCTURE FOR PROVIDING A GENERAL REQUEST/RESPONSE MESSAGING PROTOCOL USING A PRESENCE PROTOCOL,” filed on Jun. 10, 2005, and assigned to the assignee of the present application. The present application is also related to co-pending U.S. patent application Ser. No. 11/118,882 entitled “SYSTEM AND METHOD FOR UTILIZING A PRESENCE SERVICE TO ADVERTISE ACTIVITY AVAILABILITY,” filed on Apr. 29, 2005, and assigned to the assignee of the present application. The present application is also related to co-pending U.S. patent application Ser. No. 11/096,764, entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, and assigned to the assignee of the present application. The present application is also related to co-pending U.S. patent application Ser. No. 10/960,365, entitled “SYSTEM AND METHOD FOR UTILIZING CONTACT INFORMATION, PRESENCE INFORMATION AND DEVICE ACTIVITY,” and co-pending U.S. patent application Ser. No. 10/960,135, entitled “SYSTEM AND METHOD FOR UTILIZING CONTACT INFORMATION, PRESENCE INFORMATION AND DEVICE ACTIVITY,” both filed on Oct. 6, 2004, and both assigned to the assignee of the present application. The present application is also related to co-pending U.S. patent application Ser. No. 10/900,558, entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576, entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application. Each of the above-cited related applications is incorporated here by reference in its entirety.

### BACKGROUND

Traditionally, specialty and general information is disseminated through newspapers, magazines, and other printed media. Publishers create periodicals that focus on certain topics such as the entertainment industry, sports, world news and finance, and people interested in these topics subscribe to the periodicals. Nevertheless, the cost of printing and mailing the periodicals is often not covered by the subscription costs. To generate revenue and to subsidize the cost of publishing the periodical, publishers often place advertisements in the periodicals and charge an advertising fee. In some popular periodicals, the number of pages containing advertisements can equal or exceed the number of pages containing substantive information, which can be annoying for subscribers who are trying to read an article that is interrupted by pages of advertisements.

The Internet has transformed this traditional way of disseminating information by allowing publishers to provide information to their subscribers in electronic form, e.g., via web pages. In this mode, the information can be distributed without the costs associated with printing and postage. Moreover, the publishers can continue to collect advertising revenue by displaying advertisements in web pages.

While electronic publications provide great advantages for publishers and advertisers, subscribers to these electronic publications are still confronted with extraneous advertisements and perhaps uninteresting content. Currently, a subscriber has very little control over the type of information he or she receives within the general focus of the publication. For example, a subscriber to an electronic publication focusing on the music industry generally cannot control the articles that will be published in the electronic publication. In some instances, the publisher might allow the subscriber to indicate a particular genre of music, e.g., classical, jazz, or hip-hop, in which the subscriber is interested in receiving information, but generally, the subscriber has very little flexibility in customizing the subscription. For example, the subscriber cannot indicate a preference within a genre such as Bach within the classical music genre or be-bop within the jazz genre.

In order to provide this flexibility to the subscriber, the publisher could allow the subscriber to customize the content of the subscription by selecting or indicating his or her preferences. In some instances, the publisher assigns a separate URI to the customized subscription so that the subscriber can use the associated URI to fetch the custom information. Nevertheless, this method requires unique setup instructions for each associated URI. The URI must be mapped to the custom subscription, which is then mapped to an application that can prepare the custom content. As the number of custom subscriptions increase, the number of URIs increase and the cost of managing the URIs becomes prohibitive. Moreover, the URIs associated with custom subscriptions are more complicated and lengthy then the URI associated with a standard subscription, and therefore more difficult for the subscriber to remember.

In other instances, the publisher maintains the URI associated with a standard subscription, but utilizes custom filters that filter the total information available to generate the custom content. Nevertheless, the number of custom filters is directly related to a degradation in the performance of the publisher's servers. That is, as the number of custom filters increases, the speed at which the custom information is provided decreases.

Moreover, some online web publishers can tailor the contents of a webpage based on the recipient's expressed preferences and perhaps on the recipient's browsing habits. Nevertheless, such subscriptions are HTTP subscriptions. As such, the recipient receives information only upon request, i.e., the recipient must fetch the information. Thus, if the recipient does not explicitly fetch the information, the information received may be hours or days old.

### SUMMARY

Accordingly, methods and systems are described for providing customized subscription data. According to an exemplary embodiment, a method is described for receiving a subscription request for a tuple via a publish/subscribe protocol from a subscriber, and sending a first message related to the subscription request to a publisher capable of providing customized information associated with the tuple, where the customized information is based on a characteristic of the first message. The method further includes receiving from the publisher a second message including the customized information and in response to receiving the second message, constructing a notification including the customized information and using the publish/subscribe protocol to send the notification including the customized information to the subscriber.

According to another exemplary embodiment, a method is described for receiving in a publisher service a notification of a subscription related to a resource and creating a profile associated with the notification of the subscription, the profile created using a characteristic of the notification of the subscription. Thereafter, the publisher is configured to use the profile to generate customized information related to the resource, wherein the customized information is based on the characteristic, and to send the customized information to a publish/subscribe service for delivery to a subscriber associated with the subscription.

According to another exemplary embodiment, a system for providing customized subscription data from a publisher to a subscriber is described including a publish/subscribe service configured to receive from the subscriber a subscription request for a tuple, to create a first message related to the subscription request to be sent to the publisher, to receive from the publisher a second message including customized information, wherein the customized information is based on a characteristic of the first message, to construct a notification including the customized information, and to send the notification including the customized information to the subscriber. A communications protocol stack component coupled to the publish/subscribe service is configured to allow the publish/subscribe service to receive and send the subscription request and to receive and send the customized information using a publish/subscribe protocol.

According to yet another exemplary embodiment, a publishing system is described for providing customized subscription information. The publishing system includes a resource and a publisher service coupled to the resource. The publisher service includes a publisher application configured to generate customized information related to the resource. A resource agent component coupled to the publisher application is configured to receive a notification of a subscription for information related to the resource, to receive customized information based on a characteristic of the notification, and to publish the customized information to a subscriber associated with the subscription. The publisher application is further configured to create a profile for the subscription based on the characteristic of the notification.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 illustrates an exemplary system for providing customized information from a publisher service to a subscriber via a publish/subscribe service according to an exemplary embodiment.

FIG. 2 illustrates an exemplary publish/subscribe server that includes a publish/subscribe service according to an exemplary embodiment.

FIG. 3 illustrates an exemplary publisher service that is scalable according to an exemplary embodiment.

FIG. 4 illustrates a tuple associated with a resource according to an exemplary embodiment.

FIG. 5 is a flowchart illustrating a method for providing customized subscription information according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

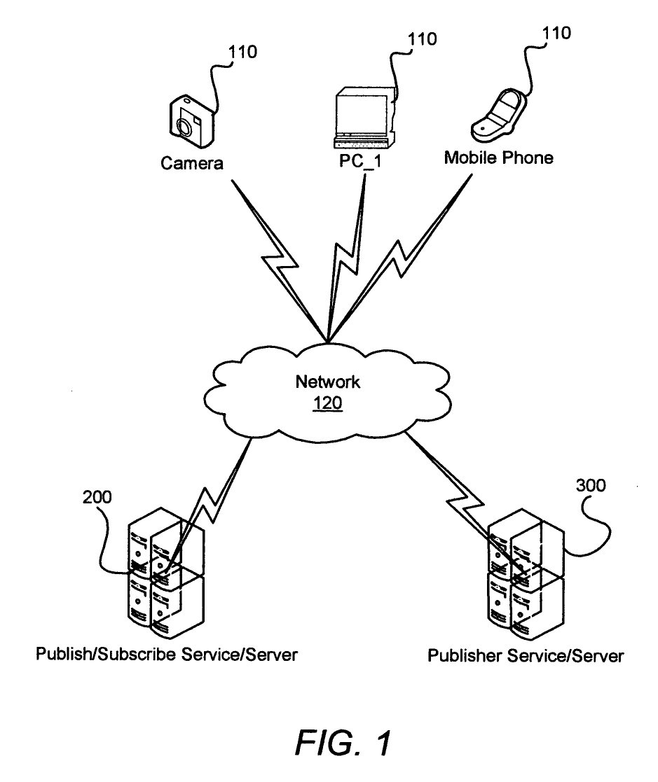

FIG. 1 is an exemplary system for providing customized subscription data according to an exemplary embodiment. The system 100 includes a plurality of subscribers 110, a publish/subscribe (pub/sub) server 200, and a publisher service 300. The subscribers 110, pub/sub server 200 and publisher service 300 are communicatively coupled by a network 120, such as the internet. As is shown, the subscriber 110 can be a network-enabled camera, desktop or laptop computer, a mobile telephone, and the like.

According to an exemplary embodiment, the subscriber 110 is configured to send to the pub/sub server 200 a subscription request for a tuple associated with a resource. The subscription request includes a common resource identifier, such as a Uniform Resource Identifier (URI), associated with the tuple. In one embodiment, the subscription request includes customization criteria for customized information related to the resource. The criteria can include custom content, custom formatting, custom delivery conditions, or any other custom conditions. In another embodiment, the subscription request is generic, i.e., not customized, but the publisher service 300 customizes the subscription information based on a characteristic of the subscription request notification. For instance, the custom subscription information can be based on when the subscription request was received, where the subscriber 110 is located, or who the subscriber is. Notably, the tuple to which the subscriber is subscribing is the same tuple regardless of whether the subscription request involves custom or standard information. Accordingly, all subscription requests, custom or standard, related to the resource are implemented using the same URI.

The pub/sub server 200 receives the subscription request for the tuple and notifies the publisher service 300, which is capable of generating the customized information relating to the resource. According to an exemplary embodiment, the publisher service 300 can be a pub/sub client configured to provide the customized subscription information to a subscriber 110 using a pub/sub communication protocol via the pub/sub service 200, but other arrangements are contemplated. For example, all messages between the publisher service 300 and the pub/sub server 200 can be exchanged using a request/response (e.g., HTTP) or other synchronous communication protocol. Alternatively, messages sent from the pub/sub server 200 to the publisher service 300 can be carried using one type of protocol (e.g., request/response or HTTP) while messages sent from the publisher service 300 to the pub/sub server 200 can be carried using a different protocol (e.g., pub/sub or presence), and vice versa.

The pub/sub communication protocol is a well-known asynchronous communication protocol in which commands are structured such that a sender of information via the protocol need not wait for a response from a receiver after the receiver is notified of the information. In a pub/sub protocol, senders of information (or publishers) post (or publish) messages with specific topics rather than sending messages to specific recipients. The pub/sub service 200 then selectively transmits the posted messages (through what are referred to as notify messages) to all interested parties, i.e., subscribers 110. The published information can be read simultaneously by any number of subscribers 110.

Other pub/sub communication protocols include presence protocols, such as those described in “Request for Comments” (RFC) document RFC 2779 to Day et al., titled “Instant Messaging/Presence Protocol” (February, 2000) and RFC 3921 to Saint-Andre, titled “Extensible Messaging and Presence Protocol (XMPP): Instant Messaging and Presence” (October, 2004), each published and owned by the Internet Society. Another presence protocol is the Session Initiation Protocol (SIP) for Instant Messaging and Presence Leveraging Extensions (or SIMPLE). SIMPLE is an application of the SIP protocol (see RFC 3261 to Rosenberg, et. al., titled “SIP: Session Initiation Protocol”; IETF, June, 2002) for server-to-server and client-to-server interoperability in instant messaging. For convenience, the exemplary embodiments described here employ a presence protocol as the pub/sub communications protocol. Nevertheless, the techniques described here can be performed using any of the pub/sub communications protocols described above.

It will be understood that some presence and pub/sub protocols do provide some level of acknowledgements for the publish and notify messages sent via the protocols. Notwithstanding this, these protocols are asynchronous as between a publisher 300 and a subscriber 110. That is, using the publish, subscribe, and notify commands of these protocols, a publisher 300 need not wait for a reply when a notification is sent to a subscriber 110, nor does the subscriber 110 need to send a request to receive information from the publisher 300.

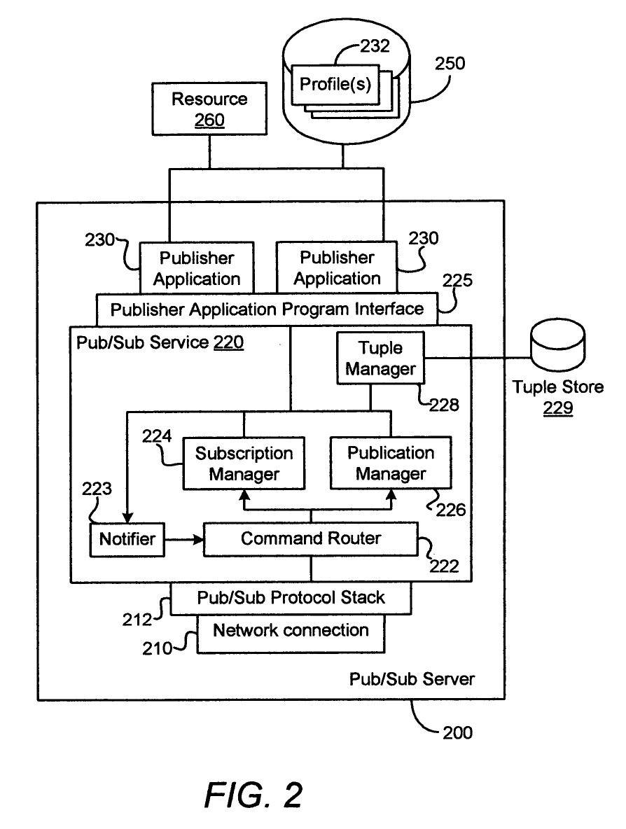

FIG. 2 is a detailed view of a pub/sub service 220 in the pub/sub server 200 according to an exemplary embodiment. The pub/sub server 200 includes a pub/sub protocol stack component 212 coupled between a network connection 210 and the pub/sub service 220. The pub/sub protocol stack component 212 is used to exchange information received or transmitted at the physical layer (e.g., the wire, air interface, or fiber optic cable) of the network 120, through the data link (e.g., ETHERNET, 802.11 WIFI), transport/network (e.g., TCP/IP) and application (e.g., XMPP) layers of the stack. Although only one pub/sub protocol stack 212 is shown, the pub/sub server 200 can support more than one such communication protocol stack.

The pub/sub service 220 includes a command router 222 that receives and processes pub/sub commands from the network 120 and from other components in the pub/sub service 220. For example, the command router 222 directs subscribe commands to a subscription manager 224, directs publish commands to a publication manager 226, and sends notify requests on behalf of a notifier 223. The command router 222 can also process other pub/sub commands, such as fetch and probe.

The subscription manager 224 processes subscription requests and other tasks associated with subscriptions. In one embodiment, the subscription manager 224 processes a subscription request by creating a custom tuple for the customized subscription data, and by placing the subscriber 110 on a subscription list associated with the custom tuple. In addition, the subscription manager 224 authorizes the subscriber 110, manages rosters and subscription lists, and uses the notifier 223 to construct notification messages informing the publishers 300 of subscriptions and notification messages informing subscribers 110 when new information is available. The publication manager 226 processes publish commands and coordinates with the subscription manager 244 the publication of customized data to ensure that subscribers 110, if any, are notified via the notifier 223.

The pub/sub service 220 further includes a tuple manager 228 that is coupled to a tuple store 229. The tuple manager 228 manages tuples and tuple information. It also manages rosters for security, if provided, and stores and retrieves subscription data from the tuple store 229. If the pub/sub service 220 stores published information, the tuple manager 228 also stores and retrieves the published information. As used here, a tuple is associated with an entity or object, such as the resource, and can be considered to be a representation that maps field names to certain values to indicate that the entity or object includes certain components, information, and/or perhaps has certain properties. The tuple includes information related to the resource and can include a link to other information related to the resource.

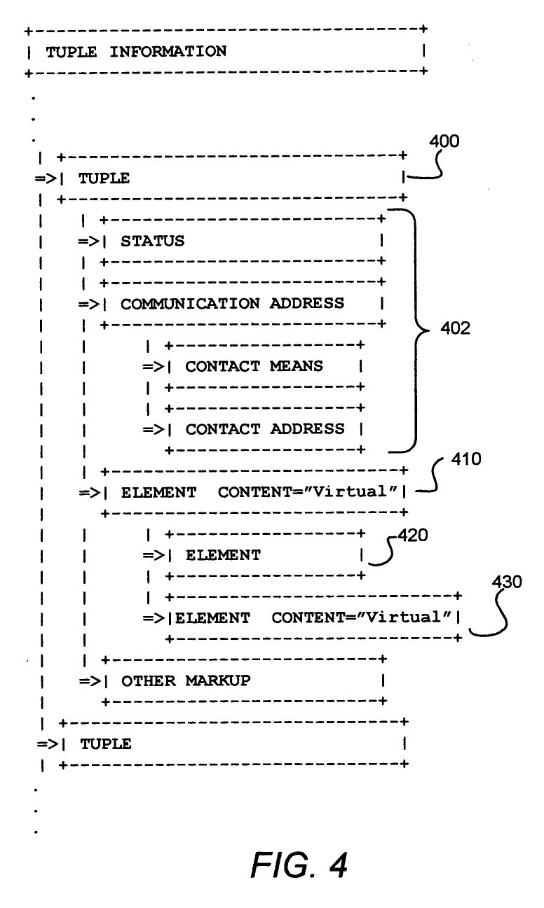

According to an exemplary embodiment, the tuple associated with the resource includes a plurality of elements or sub-tuples, at least one of which is a virtual element/sub-tuple. In one embodiment, the virtual element/sub-tuple is simply an identifier without fixed structure or content. In one embodiment, its XML representation can be identified as virtual by using an attribute value related to its “CONTENT.” For example, FIG. 4 illustrates an exemplary tuple 400 that includes a virtual element. As shown, the tuple 400 includes elements or sub-tuples 402 that store typical presence information for the resource, such as status, communication address, contact means and contact address. As shown, the virtual sub-tuple 410 can be given a CONTENT attribute having a “virtual” value, and can include both actual, i.e., non-virtual, elements 420, as well as virtual 430 elements. Information stored in the actual elements 420 is published to all subscribers 110, whereas the virtual elements 430 can be empty or can contain data.

In one embodiment, the subscription manager 224 uses the virtual elements 430 in the tuple 400 to pass customization data relating to a subscription to the publisher service 300. By providing the virtual sub-tuple 410 in the tuple 400, one URI associated with the tuple 400 can be used to submit and manage custom and standard subscriptions related to the resource. Accordingly custom URIs are not required for custom subscriptions, thereby simplifying the subscription process for the subscriber 110.

Although the tuple 400 illustrated in FIG. 4 is a presence tuple, the tuple 400 need not be a presence tuple, per se, nor need the tuple 400 be exchanged via a pub/sub service 220. Any tuple structure can be used with the techniques described here. Moreover, persons skilled in the art will understand that the data represented by a tuple may be stored in any format, including binary data or other proprietary data formats. As such, the tuple structure simply provides the external representation of the underlying data structure of the tuple information related to the resource. For example, a well-formed XHTML document can be a tuple.

Referring again to FIG. 2, the pub/sub server 200 can also include a publisher application programming interface (API) 225 coupling a plurality of publisher applications 230 to the pub/sub service 220. The publisher API 225 allows the pub/sub service 220 to pass subscription notification messages to any one of the publisher applications 230. In an exemplary embodiment, the publish API 230 is independent of both the transport and pub/sub protocol such that messages can be exchanged freely between the pub/sub service 220 and any of the publisher applications 230.

Each publisher application 230 is configured to generate customized subscription information relating to a resource 260 according to a characteristic associated with the subscription notification message. In one embodiment, the characteristic can be associated with the subscriber 110 or a group to which the subscriber 110 belongs. For example, the characteristic can be a subscriber ID or group ID. In another embodiment, the characteristic can be associated with the notification message itself. For example, the characteristic can be the time the subscription request is received by the pub/sub service 220 or the order in which the subscription is received in the context of other requests. In another embodiment, the characteristic can be a combination of characteristics associated with the subscriber 110, e.g., identity, location, status, and characteristics associated with the notification message.

The publisher application 230 is configured to create a profile 232 for the subscription based on the characteristic of the notification message. In one embodiment, the profile 232 is created using the characteristic, and includes other data used to determine the customization, such as content and a schema for presenting the customized information. The schema can be customized by the subscriber, e.g., via subscription parameters, or can be set by the publisher application 230. The profile data can include dynamic parameters (e.g., the subscriber's location and status), as well as static parameters such as a set of configured preferences.

In an exemplary embodiment, the profile 232 is stored in a storage device, such as a database 250, such that when an event related to the resource 260 is detected, the publisher application 230 can retrieve the profile 232 and use it to determine whether the subscriber 110 should be notified, what data should be sent, and the format of the customized data.

The customized information is transmitted from the publisher application 230 to the pub/sub service 220 via the publisher API 230 for delivery to the subscriber 110. In one embodiment, the customized information can be transmitted to the subscriber 110 using the virtual elements 430 (FIG. 4) of the virtual sub-tuple 410 of the tuple 400 associated with the resource 260 and the notifier 223 can construct a notification message to be delivered to the subscriber 110 via a directed notify command. In this embodiment, a custom tuple for the customized information is not required. In another embodiment, if the custom tuple has been created and the subscription placed in a subscription list associated with the custom tuple, the custom tuple can be updated with the customized information and the notifier 223 can construct a notification message to be delivered to the subscriber 110 based on the subscriber's subscription to the custom tuple.

According to the exemplary embodiment illustrated in FIG. 2, the pub/sub server 200 can host the publisher applications 230 and publish customized subscription information via the pub/sub service 220. Alternatively, or in addition, the pub/sub server 200 can support remote publisher services 300 using the pub/sub communication protocol.

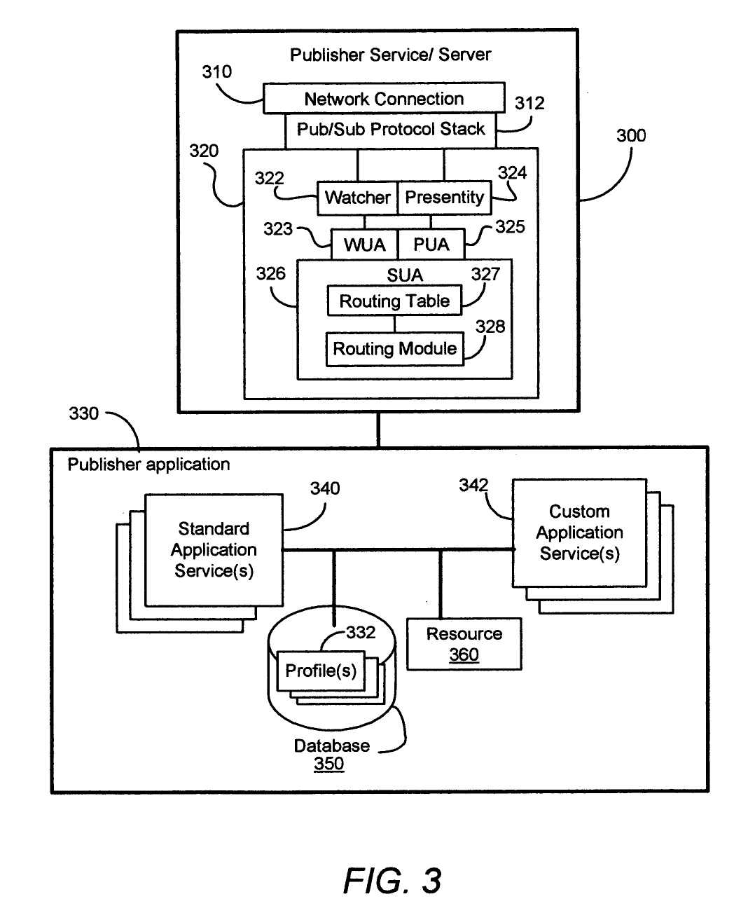

FIG. 3 illustrates an exemplary publisher service 300 according to an exemplary embodiment. The publisher service 300 is coupled to a resource 360 and is analogous to the publisher application 230 (FIG. 2) in the pub/sub service 220 except that communications between the publisher service 300 and the pub/sub server 200 are conducted via the pub/sub communication protocol. Accordingly, like the pub/sub server 200, the publisher service 300 includes a network connection 310 coupled to a pub/sub protocol stack 312 that is used to exchange information received or transmitted at the physical layer (e.g., the wire, air interface, or fiber optic cable) of the network 120, through the data link (e.g., ETHERNET, 802.11 WIFI), transport/network (e.g., TCP/IP) and application (e.g., XMPP) layers of the stack. Although only one pub/sub protocol stack 312 is shown, the publisher service 300 can support more than one such communication protocol stack.

In an exemplary embodiment, the publisher service 300 is a pub/sub client and includes a resource agent component 320 between the pub/sub protocol stack 312 and a publisher application 330. The resource agent component 320 is configured to receive from the pub/sub server 200 a notification of a subscription related to the resource 360, to receive customized information related to the resource from the publisher application 330, and to send the customized information to the pub/sub server 200 so that it can be delivered to the subscriber 110.

In the related exemplary case where the pub/sub communication protocol is a presence protocol, the resource agent component 320 can include a watcher component 322 and an associated WUA 323 configured to receive and process the notification from the presence (pub/sub) server 200. The resource agent component 320 can also include a presentity component 324 and an associated PUA 325 configured to publish customized information to the presence server 200. For example, the presentity/PUA 324, 325 can be configured to publish to the presence server 200 the customized subscription information in the virtual element 430 (FIG. 4) of the tuple 400 associated with the resource. According to an exemplary embodiment, the resource agent component 320 can also include a service user agent (SUA) component 326 that interacts with the publisher application 330 as its principal, although the SUA component 326 can also interact with an owner of the application 330 as well as other principals.

According to an exemplary embodiment, the publisher application 330 is functionally equivalent to the publisher applications 230 described above that are hosted by the pub/sub server 200. That is, the publisher application 330 is configured to create customized subscription information related to the resource 360. The customized information is based on a characteristic of the notification of the subscription from the pub/sub service 220. In one embodiment, the characteristic can be associated with the subscriber 110 or a group to which the subscriber 110 belongs, or the characteristic can be associated with the notification message itself, or the characteristic can be a combination of characteristics associated with the subscriber 110 and those associated with the notification message.

The publisher application 330 is configured to create a profile 332 for the subscription based on the characteristic of the notification. In one embodiment, the profile 332 is created using the characteristic, and includes other data used to determine the customization, such as content and a schema for presenting the customized information. The schema can be customized by the subscriber, e.g., via subscription parameters, or can be set by the publisher application 330. The profile 332 data can include dynamic parameters (e.g., the subscriber's location and status), as well as static parameters such as a set of configured preferences.

In an exemplary embodiment, the profile 332 is stored in a storage device, such as a database 350, coupled to the publisher service 300. When an event related to the resource 360 is detected, the publisher application 330 can retrieve the profile 332 and use it to determine whether the subscriber 110 should be notified, what data should be sent, and the format of the customized data.

In an exemplary embodiment, the publisher application 330 can be configured to direct the pub/sub service 220 to create and publish a custom tuple for the subscription and to place the subscriber 110 on a subscription list associated with the custom tuple, if such has not been already done by the pub/sub service 220. The custom tuple can then be used to publish the customized information to the subscriber 110. In another embodiment, the publisher application 330 can use the virtual elements 430 in the virtual sub-tuple 410 of the tuple 400 associated with the resource to send the customized information to the subscriber 110 using a directed publish/notify command.

In an exemplary embodiment, the publisher service 300 can be coupled to a plurality of standard application services 340 and a plurality of custom application services 342. Each application service 340, 342 includes an instance of the publisher application 330 (not shown) that is configured to generate subscription information for a subscriber 110. The publisher application 330 is then distributed across the application services 340, 342. As additional customized subscriptions are processed, custom application services 342 can be added such that the processing of standard and customized subscriptions can be distributed to a scalable application service farm.

In this embodiment, once the publisher application 330 determines that a subscriber 110 should be notified of an event related to the resource 360, the publisher application 330 uses the SUA 326 to determine which application service 340, 342 should be utilized to generate the standard or customized information for the subscriber 110. The SUA 326 is configured to manage a routing table 327 that uses the characteristic of the subscription notification to map the subscription to an application service 340, 342. For example, the routing table 327 can map a subscriber ID to an application service 342 that includes a publisher application capable of generating the customized information based on the profile associated with the subscription. Once the SUA 326 identifies the associated application service 342, the SUA 326 is configured to send a message to the identified application service 342, via a routing module 328, so that the customized information can be generated. The SUA 326 automatically updates the routing table 327 whenever the publisher service 300 receives notification of a new subscription.

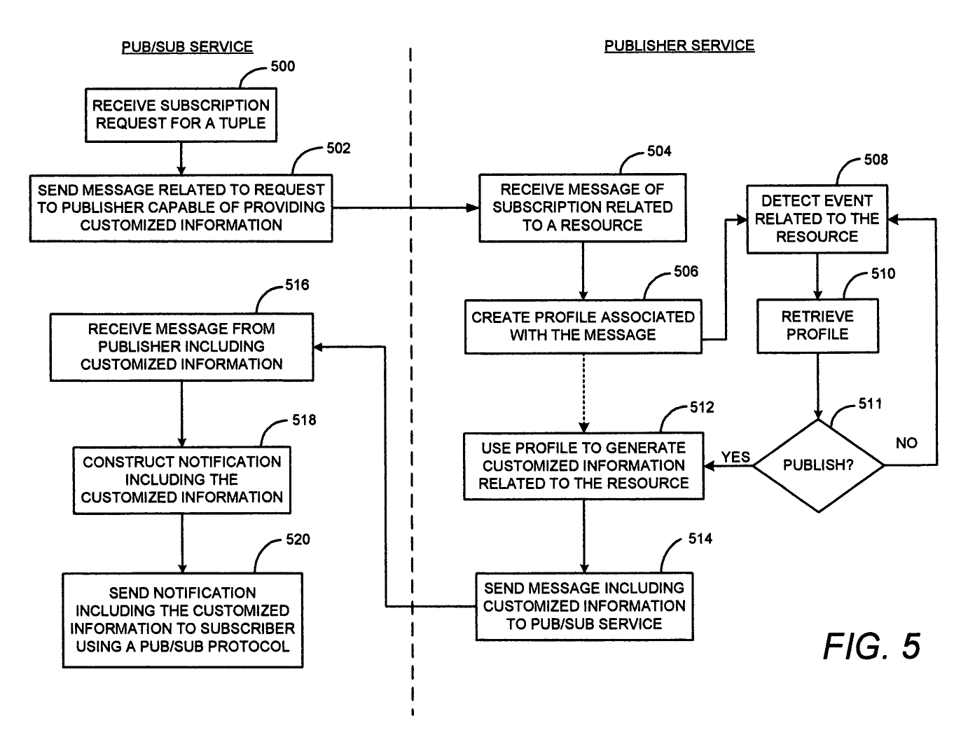

FIG. 5 depicts a flowchart illustrating an exemplary method for providing customized subscription data by the pub/sub service 220 and by the publisher service 300 according to an exemplary embodiment. The method can be carried out using the arrangement described in conjunction with FIGS. 1-3 and the data structure described in conjunction with FIG. 4 above, portions of which are referenced in the description that follows. It will be understood that other arrangements and/or data structures can be used to carry out the described method without departing from the scope of the described techniques. Descriptions of certain terms, the meanings of which are described in detail above in conjunction with FIGS. 1-4, are not repeated here.

Referring to FIG. 5, the exemplary method begins when the pub/sub service 220 in the pub/sub server 200 (shown in FIG. 2) receives a subscription request for a tuple 400 (shown in FIG. 4) from a subscriber 110 via the pub/sub protocol stack component 212 (block 500). The tuple 400 is related to a resource offered by a publisher. In an exemplary embodiment, the subscription request includes a common resource identifier, such as a URI, that is associated with the tuple 400. The common resource identifier can be used by a plurality of subscribers 110 to subscribe to standard and custom services related to the resource.

In response to receiving the subscription request, the pub/sub service 220 sends a message related to the subscription request to a publisher application 230 or to a publisher application 330 in a publisher service 300 capable of providing customized information associated with the tuple 400 (block 502). In one embodiment, the message is sent via the virtual elements 430 in the virtual sub-tuple 410 of the tuple 400, as described above. Note that the pub/sub service 220 can send the message to the publisher application 230, 330 in-band (e.g., using a pub/sub protocol) or out-of-band (e.g., using another protocol, such as HTTP) in relation to the messages exchanged between the subscriber 110 and the pub/sub server 200.

In one embodiment, the message is received by a publisher application 230 (block 504) via the publisher API 225, and in another embodiment, the message is received by a publisher application 330 in the publisher service 300 (block 504) via the pub/sub protocol stack component 312, watcher component 322 and SUA 326 (shown in FIG. 3). In the later case, the message is a notification per the pub/sub protocol.

As stated above, the publisher applications 230, 330 are configured to provide customized information associated with the tuple 400 and based on a characteristic of the message. The characteristic can be associated with the subscriber 110 or a group to which the subscriber 110 belongs, or the characteristic can be associated with the message itself, or the characteristic can be a combination of characteristics associated with the subscriber 110 and those associated with the message.

After receiving the message (or notification), the publisher application 230, 330 creates a profile 232, 332 associated with the message/notification (block 506). As stated above, the profile 232, 332 is created using the characteristic, and includes data used to determine the customization based on the characteristic, such as content and a schema for presenting the customized information. The schema can be customized by the subscriber 110, e.g., via subscription parameters, or can be set by the publisher application 240, 330. The profile data can include dynamic parameters (e.g., the subscriber's location and status), as well as static parameters such as a set of configured preferences. Accordingly, a process for creating the profile 232, 332 can include at least one of identifying the customized information based on the characteristic of the message or notification, defining the schema for presenting the customized information, identifying a triggering event that indicates when the subscriber 110 should be notified, and defining where to send the customized information.

Once the profile 232, 332 is created, the publisher application 230, 330 can use it to generate the customized information related to the resource 260, 360. In one embodiment, the publisher application 230, 330 can generate the customized information related to the current state of the resource 260, and send it to the pub/sub service 220 for delivery to the subscriber 110 immediately after the profile 232, 332 has been created. The profile 232, 332 is stored in a storage device, e.g., 250, 350, where the publisher application 230, 330 can access it when needed.

At this point, the publisher application 230, 330 waits for a triggering event to occur. For example, the triggering event can be a time stamp, a change in state, or an update related to the resource. The publisher application 230, 330 detects the event related to the resource (block 508) and retrieves the profile(s) 232, 332 (block 510) to determine whether information related to the event should be published to the subscriber 110 based on the profile 332. If the publisher application 230, 330 determines that the information should be published (block 611), the publisher application 230, 330 uses the profile 232, 332 to generate the customized information related to the resource 260, 360 (block 512).

In one embodiment where a plurality of standard 340 and custom 342 application services are coupled to the publisher service 300 (shown in FIG. 3), the publisher application 330 uses the SUA 326 to identify which application service 340, 342 should be utilized to generate the standard or customized information for the subscriber 110. Once determined, the publisher application 330 uses the SUA 326 to route a call to the identified application service 340, 342, which then uses the profile 332 to generate the customized information based on the characteristic. The customized information is then returned to the publisher application 330.

The publisher application 230, 330 then sends a message including the customized information to the pub/sub service 220 for delivery to the subscriber 110 (block 514). In the case where the publisher application 330 is in the publisher service 300, the message is a publication and is sent from the publisher application 330 to the pub/sub service 220 via the SUA 326, presentity component 324 and pub/sub protocol stack 312. Note again that the publisher application 230, 330 can send the message to the pub/sub server 200 in-band or out-of-band.

The pub/sub service 220 receives the message (block 516) including the customized information. The message directs the pub/sub service 220 to publish the customized information to a tuple associated with the customized information. In one embodiment, the associated tuple is a custom tuple created by the pub/sub service 220 either automatically when the subscription request was received or upon request from the publisher application 230, 330 when the subscription is processed. In this embodiment, the subscriber 110 is added to a subscription list associated with the custom tuple. In another embodiment, the associated tuple is the tuple 400 associated with the resource. The virtual elements 430 of the virtual sub-tuple 410 are used to publish the customized information. In this embodiment, the message also directs the pub/sub service 220 to publish the customized information specifically to the subscriber 110. For example, in the pub/sub protocol, such a message includes a directed publish command.

In response to receiving the message from the publisher application 230 or publisher service 300, the pub/sub service 220 constructs a notification message that includes the customized information (block 518). In an exemplary embodiment, the notifier 223 builds the notification message by updating the custom tuple associated with the customized information, or by providing data for the virtual elements 430 of the tuple 400 associated with the resource 260, 360. The notification message is then passed to the command router 222, which sends the notification to the subscriber 110 via the pub/sub protocol stack 212 using a notify command in response to the subscriber's subscription to the custom tuple, or using a directed notify command (block 520).

The executable instructions of a computer program as illustrated in FIG. 5 can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Methods and systems for providing customized subscription data have been described. In one embodiment, subscriptions between publishers and subscribers are managed through a pub/sub service using a pub/sub communication protocol. The pub/sub service implements standard or custom subscriptions related to a resource using a common resource identifier of a tuple associated with the resource. Because each custom subscription does not require a unique identifier, the common resource identifier can be simple and the subscriber need only be aware of the common identifier. In addition, because the subscription relationship is implemented using a pub/sub communication protocol, the subscriber can receive updated customized information from the publisher automatically, i.e., without requesting it, and in substantially real-time.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for providing customized subscription data, the method comprising:
receiving a subscription request for a tuple via a publish/subscribe protocol from a subscriber;
sending a first message related to the subscription request to a publisher capable of providing customized information associated with the tuple, wherein the customized information is based on a characteristic of the first message;
receiving from the publisher a second message including the customized information;
in response to receiving the second message, constructing a notification including the customized information; and
using the publish/subscribe protocol to send the notification including the customized information to the subscriber.

2. The method of claim 1 wherein the subscription request includes a common resource identifier associated with the tuple and used by a plurality of subscribers to subscribe to a plurality of services offered by the publisher.

3. The method of claim 1 wherein the tuple includes a plurality of elements and wherein the plurality of elements includes a virtual element associated with the customized information.

4. The method of claim 3 wherein sending the first message includes using the virtual element of the tuple.

5. The method of claim 3 wherein sending the notification including the customized information includes using the virtual element of the tuple.

6. The method of claim 5 wherein the second message received from the publisher includes a directed publish/notify command to the subscriber.

7. The method of claim 1 further comprising:
after receiving the subscription request, allowing a custom tuple associated with the customized information to be created; and
placing the subscriber in a subscriber list associated with the custom tuple such that the subscriber in the subscriber list is notified of any updates to data in the custom tuple.

8. The method of claim 7 wherein constructing the notification includes updating the custom tuple.

9. The method of claim 1 wherein the notification including the customized information is sent to the subscriber in substantially real-time in relation to constructing the notification.

10. The method of claim 1 further including:
providing a publish/subscribe service module for processing messages to and from subscribers using the publish/subscribe protocol;
hosting a publishing application, wherein the publishing application is configured to provide the customized information; and
coupling the publishing application to the publish/subscribe service via an application programming interface, wherein the publish/subscribe service is configured to process messages to and from the publishing application via the application programming interface.

11. The method of claim 10 further including:
receiving by the publishing application the first message related to the subscription request;
creating by the publishing application a profile associated with the first message, wherein the profile is created using the characteristic of the first message and includes a schema for the customized information; and
using the profile to construct the second message including the customized information.

12. A method for providing customized subscription information comprising:
receiving in a publisher service a notification of a subscription related to a resource;
creating a profile associated with the notification of the subscription, the profile created using a characteristic of the notification of the subscription;
using the profile to generate customized information related to the resource, the customized information based on the characteristic; and
sending the customized information to a publish/subscribe service for delivery to a subscriber associated with the subscription.

13. The method of claim 12 wherein a tuple is associated with the resource by the publish/subscribe service for providing the customized information.

14. The method of claim 13 wherein sending the customized information to a publish/subscribe service includes:
using a directed publish/notify command to allow the publish/subscribe service to deliver the customized information to the subscriber.

15. The method of claim 13 wherein the tuple is a custom tuple associated with the customized information and is created for the subscription, and the subscriber is on a subscriber list associated with the custom tuple, and wherein sending the customized information includes directing the publish/subscribe service to publish the customized information to the custom tuple.

16. The method of claim 12 wherein creating the profile includes at least one of: identifying the customized information based on the characteristic of the notification of the subscription, defining a schema for presenting the customized information, identifying a triggering event, and defining where to send the customized information.

17. The method of claim 16 further comprising:
detecting an event related to the resource;
determining whether information related to the event should be published based on the profile for the subscription; and
generating the customized information according to the profile when the profile indicates the information related to the event is to be published.

18. A system for providing customized subscription data from a publisher to a subscriber, the system comprising:
a publish/subscribe service configured to receive from the subscriber a subscription request for a tuple, to create a first message related to the subscription request to be sent to the publisher, to receive from the publisher a second message induding customized information, wherein the customized information is based on a characteristic of the first message, to construct a notification including the customized information, and to send the notification including the customized information to the subscriber; and
a communications protocol stack component coupled to the publish/subscribe service configured to allow the publish/subscribe service to receive the subscription request and to send the notification including the customized information using a publish/subscribe protocol.

19. The system of claim 18 wherein the subscription request includes a common resource identifier associated with the tuple and used by a plurality of subscribers to subscribe to a plurality of services offered by the publisher.

20. The system of claim 18 wherein the tuple includes a plurality of elements and wherein the plurality of elements includes a virtual element associated with the customized information, and wherein the publish/subscribe service includes a subscription manager configured to create the first message using the virtual element of the tuple.

21. The system of claim 20 wherein the subscription manager is configured to generate the notification by using the virtual element of the tuple.

22. The system of claim 21 wherein the publish/subscribe service is configured to send the notification including the customized information to the subscriber using a directed notify command.

23. The system of claim 18 wherein the publish/subscribe service includes a subscription manager configured to create a custom tuple associated with the customized information, and to place the subscriber in a subscriber list associated with the custom tuple.

24. The system of claim 23 wherein the publish/subscribe service is configured to construct the notification by updating the custom tuple associated with the customized information.

25. The system of claim 18 wherein the publish/subscribe service includes a publication manager configured to publish a custom tuple associated with the customized information from the publisher, and to place the subscriber in a subscriber list associated with the custom tuple.

26. The system of claim 18 further comprising a publishing application coupled to the publish/subscribe service via an application programming interface, the publishing application configured to provide customized information, and wherein the publish/subscribe service is further configured to process messages to and from the publishing application via the application programming interface.

27. The system of claim 26 wherein the publishing application is configured to receive the first message related to the subscription request, to create a profile associated with the subscription, wherein the profile is created using a characteristic of the first message and includes a schema for the customized information, and to use the profile associated with the subscription to send a message to the publish/subscribe service, the message including the customized information.

28. A publishing system for providing customized subscription information, the system comprising:
a resource; and
a publisher service associated with the resource, wherein the publisher service comprises:
a publisher application configured to generate customized information related to the resource; and
a resource agent component coupled to the publisher application, the resource agent component configured to receive a notification of a subscription for information related to the resource, to receive customized information based on a characteristic of the notification from the publisher application, and to send the customized information to a publish/subscribe service for delivery to a subscriber associated with the subscription;
wherein the publisher application is further configured to create a profile associated with the subscription based on the characteristic of the notification.

29. The publishing system of claim 28 further comprising a storage device coupled to the publisher service, the storage device configured to store the profile.

30. The publishing system of claim 29 wherein the publisher application is further configured to retrieve the profile from the storage component and to generate the customized information based on the profile.

31. The publishing system of claim 28 further comprising:
a plurality of service applications coupled to the publisher service, wherein each of the plurality of service applications includes a publisher application configured to generate customized information based on the characteristic associated with the notification.

32. The publishing system of claim 31 wherein the resource agent component is further configured to manage a routing table that uses the characteristic associated with the notification to map the subscription to a publisher application in a service application of the plurality of service applications.

33. The publishing system of claim 32 wherein the resource agent component is further configured to use the routing table to route a message to the publisher application in the service application capable of generating the customized information.

34. The publishing system of claim 28 wherein the resource agent component is further configured to direct the publish/subscribe service to publish the customized information to a tuple.

35. The publishing system of claim 34 wherein the tuple is not exclusively associated with the customized information and wherein the resource agent component is configured to send a directed publish command to the publish/subscribe service such that the publish/subscribe service sends the customized information to the subscriber using a directed notify command.

36. A computer readable medium including a computer program for providing customized subscription data, the computer program comprising instructions executable in a service for:
receiving a subscription request for a tuple via a publish/subscribe protocol from a subscriber;
sending a first message related to the subscription request to a publisher capable of providing customized information associated with the tuple, wherein the customized information is based on a characteristic of the first message;
receiving from the publisher a second message including the customized information;
in response to receiving the second message, constructing a notification including the customized information; and
using the publish/subscribe protocol to send the notification including the customized information to the subscriber.
